(19) United States
(12) Patent Application Publication
(10) Pub. No.: US 2007/0085310 A1
(43) Pub. Date: Apr. 19, 2007

(54) Gas generator for a vehicle occupant restraint system and airbag module having such a gas generator

(75) Inventors: Jens Debler, Herlikofen (DE); Joachim Lutz, Schechingen (DE)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Automotive GmbH

(21) Appl. No.: 11/545,317

(22) Filed: Oct. 10, 2006

(30) Foreign Application Priority Data
Oct. 17, 2005 (DE) 10 2005 049 554.0

(51) Int. Cl. B60R 21/276; B60R 21/26

(52) U.S. Cl. 280/736; 280/740

(57) ABSTRACT

A gas generator (8) for a vehicle occupant restraint system includes a gas generator housing (25), the gas generator housing (25) defining a distribution chamber (14) and a generator chamber (12) from which gas flows into the distribution chamber (14) after the gas generator (8) has been activated, the distribution chamber (14) having at least one first outflow opening (26) that conveys the gas into an airbag (24), the distribution chamber (14) further having a pyrotechnical device (18) that, when it is triggered, releases at least one second outflow opening (28) in order to discharge gas to the environment.

The invention also relates to an airbag module having such a gas generator (8).

### TECHNICAL FIELD

The present invention relates to a gas generator for a vehicle occupant restraint system as well as to an airbag module having such a gas generator. The gas generator includes a gas generator housing defining a distribution chamber and a generator chamber from which gas flows into the distribution chamber after the gas generator has been activated, the distribution chamber having at least one first outflow opening that conveys the gas into an airbag.

### BACKGROUND OF THE INVENTION

The use of airbag modules in which an airbag can be filled with gas by means of a gas generator is a standard feature of modern vehicle occupant restraint systems. In order to be able to produce such airbag modules cost-effectively in large numbers of units, the industry endeavors to use identical components to the greatest extent possible. In addition to the advantage in terms of the production of the module, this also translates into advantages for the assembly of the airbag module, since a uniform installation space as well as a standardized attachment can be provided. Another objective pertaining to the production of airbag modules is the simple adaptation of the modules to customer wishes, to special aspects of a given vehicle series or to different international regulations and requirements made of vehicle occupant restraint systems. It would be particularly advantageous if these adaptations of the airbag module could be made merely through structural changes to one or just a few components of the module assembly such as, for example, to the gas generator.

Consequently, the object of the present invention is to further develop an existing airbag module system in such a way that additional requirements such as the venting of generator gas into the environment can be met especially simply and efficiently.

### BRIEF SUMMARY OF THE INVENTION

According to the invention this is achieved in a gas generator for a vehicle occupant restraint system including a gas generator housing, the gas generator housing defining a distribution chamber and a generator chamber from which gas flows into the distribution chamber after the gas generator has been activated, the distribution chamber having at least one first outflow opening that conveys the gas into an airbag, the distribution chamber further having a pyrotechnical device that, when it is triggered, releases at least one second outflow opening in order to discharge gas to the environment.

Venting the gas directly from the gas generator is particularly efficient whenever generator gas—which for various reasons is not to be used for filling the airbag—has to be quickly discharged into the environment. After all, due to the high gas pressures built up in the gas generator, a large mass flow can be released through relatively small outflow openings. Moreover, this prevents unneeded gas from first flowing into the airbag in order to then flow back out via openings in the airbag. This is especially unwanted if the vehicle occupant is not seated in an optimal restraint position and if the deployment speed of the airbag should thus be low. Moreover, by means of the gas generator according to the invention, a possibility for venting generator gas is created in which no additional changes have to be made to the airbag or to a nodule housing. Furthermore, no additional openings, tethers or limiting straps are needed. A pyrotechnical device as the triggering means is particularly advantageous in view of its relatively low cost and short response time. As a rule, the use of more expensive, reversible triggering means does not entail any advantages since the relevant time periods of a few milliseconds are too short to pick up sensor signals several times in succession, to process them and to activate the triggering means accordingly.

The distribution chamber is preferably a one-piece component of the gas generator. As an alternative, it is made up of one or more parts that are permanently attached, especially by means of welding, to the rest of the generator, for example, to the outer wall of the generator chamber.

In one embodiment, the pyrotechnical device is an explosive bolt that is arranged in an outer wall of the distribution chamber. Explosive bolts are inexpensive and prefabricated pyrotechnical units that can be attached in the distribution chamber with little effort.

Preferably, several second outflow openings are provided that are arranged in such a way that they discharge outflowing gas to the environment in a shear-neutral manner, that is to say, without any resultant force being generated. Consequently, the components of the airbag module and their attachments can be retained unchanged, since no high stresses occur.

In another embodiment, the second outflow opening is integrated into the pyrotechnical device. This offers the advantage that the requisite structural changes are largely concentrated in the pyrotechnical device, in other words, in a prefabricated add-on part that is additionally provided anyway. Only a few changes have to be made to the actual gas generator.

As an alternative, a membrane can be present that divides the distribution chamber into two areas, a first area containing the first outflow opening and a second area containing the second outflow opening. The pyrotechnical device destroys the membrane after it has been activated.

In this embodiment with a membrane, the pyrotechnical device is preferably arranged in the second area of the distribution chamber. In this manner, when the gas generator is triggered, the gas flow is not hindered as a rule, i.e. without activation of the pyrotechnical device.

In particular, the gas generator can be a tubular gas generator with a tube axis, the generator chamber and the distribution chamber being arranged axially behind one another. In this case, necessary structural changes to the gas generator can easily be made without this affecting other components of the airbag module.

Preferably, the distribution chamber is formed by a separate part attached to the generator chamber. In this case, the generator chamber, together with its appertaining parts (igniter, attachment elements, etc.), remains unchanged as the main component of the gas generator. Only the distribution chamber is changed in that it now also has openings for venting the generator gas into the environment, in addition to the outflow openings to the airbag.

In one embodiment, the gas generator is a cold gas generator, the generator chamber having a chamber filled with compressed gas. In another embodiment, the gas generator is a hot gas generator, the generator chamber having a combustion chamber. This shows the extensive possibilities for using the invention, irrespective of the type of generator used.

Advantageously, the gas generator according to the invention is accommodated and attached in a module housing of an airbag module, the distribution chamber being configured in such a way that a section of the distribution chamber having the second outflow opening extends through an opening in the module housing in order to discharge gas from the airbag module to the environment. This offers the advantage that gas to be vented is not released via the module housing but rather directly from the gas generator into the environment of the module.

In another embodiment, at least one attachment bolt is provided between the distribution chamber and the module housing in order to attach the gas generator to the module housing, the pyrotechnical device for releasing the second outflow opening being integrated into this attachment bolt. As a result, the number of components is kept low, which simplifies and speeds up the assembly of the airbag module.

Preferably, the shape of the distribution chamber and the cross sections of the first and second outflow openings are coordinated with each other in such a way that, when the pyrotechnical device is triggered, a gas mass flow into the airbag is established that amounts to between 20% and 80%, preferably about 50%, of the value achieved when the second outflow opening is closed. This shows that the minor structural changes to the gas generator allow a very good control of the gas mass flow.

### BRIEF DESCRIPTION OF THE DRAWINGS

FIG. 1 shows a perspective top view and a perspective bottom view of a module according to the invention in which the gas generator according to the invention in a first embodiment is accommodated;

FIGS. 2a to c show top views of identical modules, each fitted with different gas generators;

FIGS. 3a and b show two longitudinal sections through an airbag module according to the invention and a gas generator according to the invention in the first embodiment;

FIGS. 4a and b show two longitudinal sections through an airbag module according to the invention and through a gas generator according to the invention in a second embodiment;

FIGS. 5a and b show two longitudinal sections through an airbag module according to the invention and through a gas generator according to the invention in a third embodiment;

FIGS. 6a and b show two longitudinal sections through an airbag module according to the invention and through a gas generator according to the invention in a fourth embodiment;

FIGS. 7a and b show two partial sections through an airbag module according to the invention and through a gas generator according to the invention showing two variants of the gas generator in the fourth embodiment; and

FIG. 8 shows a diagram in which the gas mass flow into an airbag is plotted over time.

### DETAILED DESCRIPTION OF THE PREFERRED EMBODIMENTS

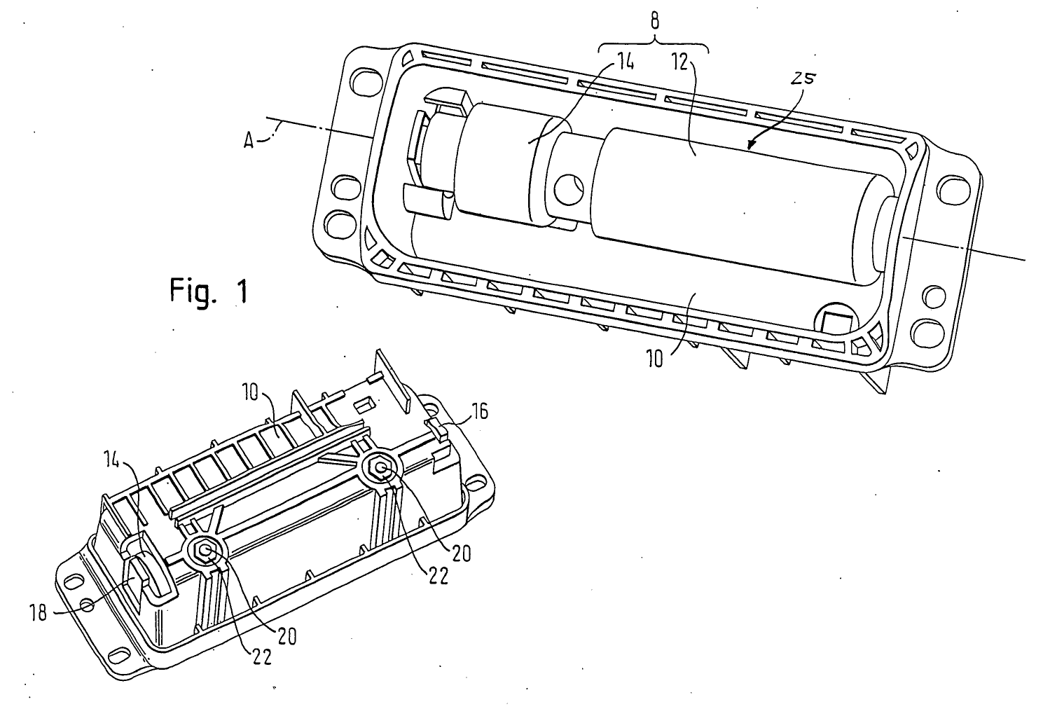

The upper part of FIG. 1 shows a top view of an airbag module having a gas generator 8 that is accommodated and attached in a module housing 10. The gas generator 8 comprises a generator chamber 12 and a distribution chamber 14, which will be discussed in greater detail below. In the present case, the gas generator 8 is a tubular gas generator with a tube axis A, the generator chamber 12 and the distribution chamber 14 being arranged axially behind one another. At its axial ends, the gas generator 8 projects through openings in the module housing 10. As a result, a triggering unit 16 for the gas generator 8 as well as a pyrotechnical device 18 on the distribution chamber 14 of the gas generator 8 can be seen in the bottom view (FIG. 1, lower depiction). Moreover, two attachment bolts 20 can be seen with which the gas generator 8 is attached to the module housing 10. For this purpose, nuts 22 are screwed onto the attachment bolts 20. In other embodiments, the gas generator 8 is latched to the module housing 10 or reliably attached in another manner.

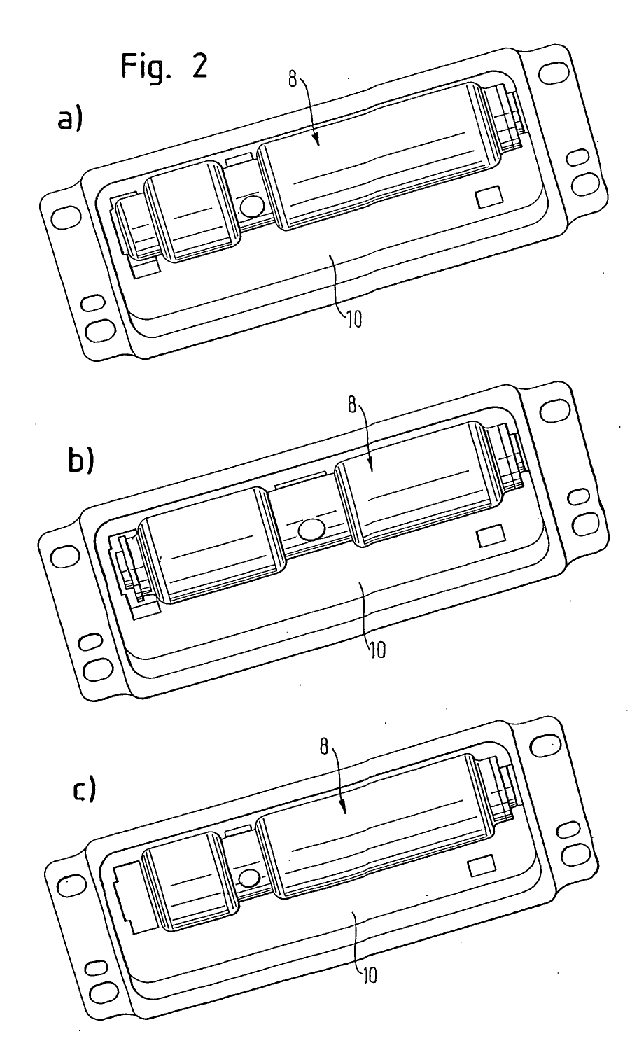

FIG. 2a, like FIG. 1, shows the gas generator 8 according to the invention and the module housing 10 in a perspective top view. FIGS. 2b and 2c show gas generators 8 according to the state of the art, FIG. 2b showing a two-stage gas generator and FIG. 2c showing a conventional, one-stage gas generator. The gas generators of FIGS. 2a to c belong to a module system in which different gas generators 8 can be installed into identical module housings 10. Thus, a module housing 10 can be used for several variants of airbag modules, which, in turn, offers the advantage that the vehicle can be provided with a uniform accommodation space and standardized attachment means.

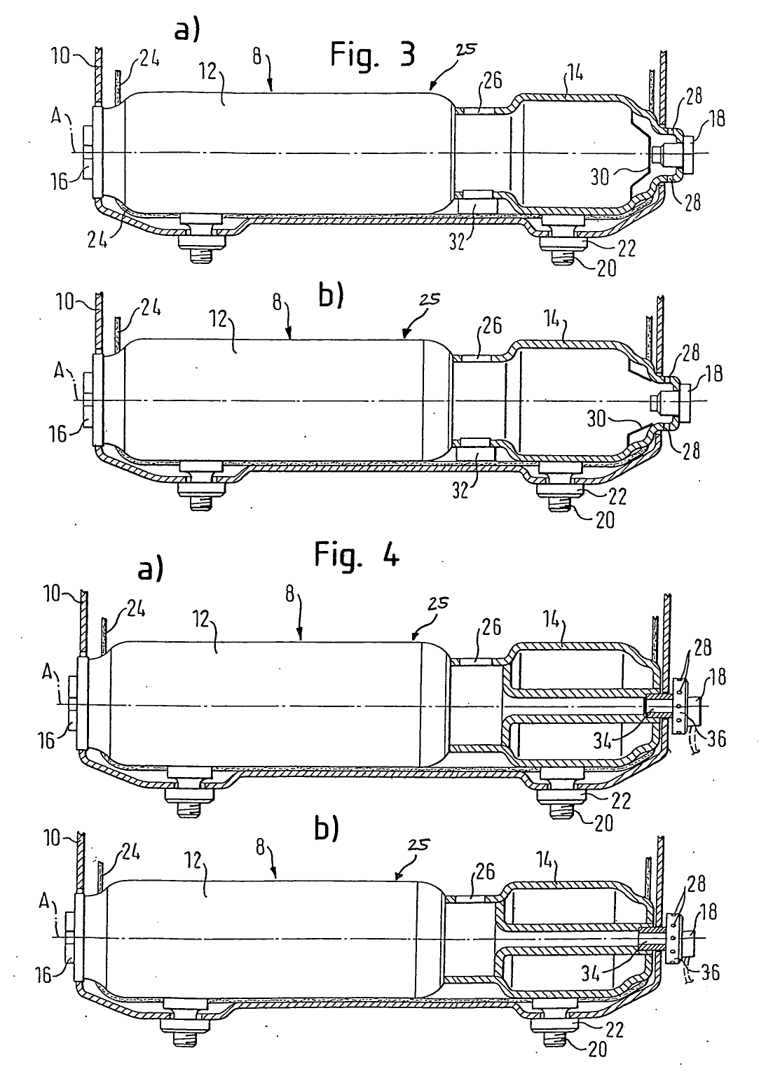

FIGS. 3a and 3b each show a section through a first embodiment of the gas generator 8 as well as through areas of the module housing 10 and through an airbag 24. The axial ends of the gas generator 8 extend through openings in the airbag 24 and in the module housing 10, so that the triggering unit 16 and the pyrotechnical device 18 are visible from outside of the module. The gas generator 8 is attached on one lengthwise side to the module housing 10 by means of the attachment bolts 20. The airbag 24 is clamped between the gas generator 8 and the module housing 10, the airbag 24 having cutouts at the attachment bolts 20.

The gas generator 8 includes a gas generator housing 25, defining the generator chamber 12 with the triggering unit 16 as well as the distribution chamber 14 with the pyrotechnical device 18. The generator chamber 12 and the distribution chamber 14 are formed by the gas generator housing 25, hence are part of the gas generator 8. The generator housing 25 can be manufactured in one piece or in several pieces being attached to one another later on. For example, the distribution chamber 14 is preferably a one-piece component of the gas generator 8. As an alternative, it is made up of one or more parts that are permanently attached, especially by means of welding, to the rest of the gas generator 8, for instance, to an outer wall of the generator chamber 12. First outflow openings 26 and second outflow openings 28 are provided in the distribution chamber 14, the first outflow openings 26 serving to convey gas into the interior of the airbag 24 and said second outflow openings 28 serving to vent gas from the airbag module into the environment. In FIG. 3a, the distribution chamber 14 is divided by a membrane 30 into a first area provided with the first outflow openings 26 and a second area provided with the second outflow openings 28. One of the two first outflow openings 26, facing the module housing 10 in the direction of the attachment bolts 20, is closed by means of a sealing plug 32. In this manner, when the gas flows out, shear forces are avoided that would move the gas generator 8 and the module housing 10 away from each other and would subject the attachment bolts 20 to tensile loading.

The pyrotechnical device 18 is arranged in the second area of the distribution chamber adjacent to the membrane 30. When the pyrotechnical device 18 is triggered, the membrane 30 is destroyed so that the second outflow openings 28 are exposed (FIG. 3b). Since the second outflow openings 28 lie in the flow direction of the generator gas at one axial end of the gas generator 8, these second outflow openings 28 can discharge a substantial gas mass flow to the environment even though the total cross section of the second outflow openings 28 is generally considerably smaller than the total cross section of the first outflow openings 26. The second outflow openings 28 are preferably arranged in a shear-neutral manner.

FIGS. 4 to 7 show additional embodiments of the gas generator 8 and of the airbag module. In general, the same applies that was mentioned for FIGS. 3a and 3b, except that special features of the individual embodiments are discussed. Corresponding components have the same reference numerals in the drawings.

FIGS. 4a and 4b show a second embodiment of the gas generator 8 and the airbag module. Here, the difference from FIGS. 3a and 3b is that the axial end of the gas generator 8 on the side of the distribution chamber 14 is not passed through the module housing 10. Instead, the pyrotechnical device 18 extends from the gas generator 8, or to put it more precisely, from the distribution chamber 14 of the gas generator 8 through the module housing 10 to outside of the module housing 10. In this case, the pyrotechnical device 18 is configured as an igniter or explosive bolt that, after being actuated, opens an outflow channel 34 and thus the second outflow openings 28 (FIG. 4b). The explosive bolt is permanently attached, for example welded to the gas generator 8 and, outside of the module housing 10, has a distribution cap 36 that vents outflowing gas in a radial direction in a shear-neutral manner.

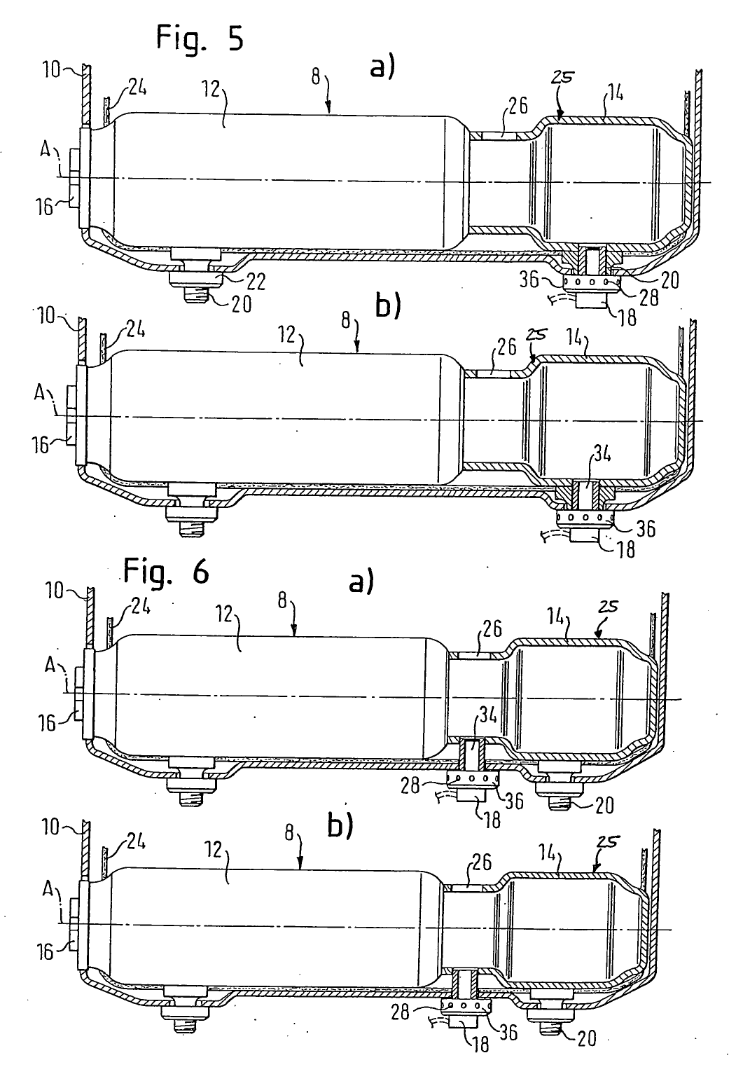

The mode of operation of the gas generator 8 in a third embodiment according to FIGS. 5a and 5b is largely analogous to that of FIGS. 4a and 4b. Here, too, the pyrotechnical device 18 is configured as an explosive bolt with a distribution cap 36, although the pyrotechnical device 18 is not installed at one axial end of the gas generator 8 but rather, it is integrated radially and in the attachment bolt 20 of the distribution chamber 14.

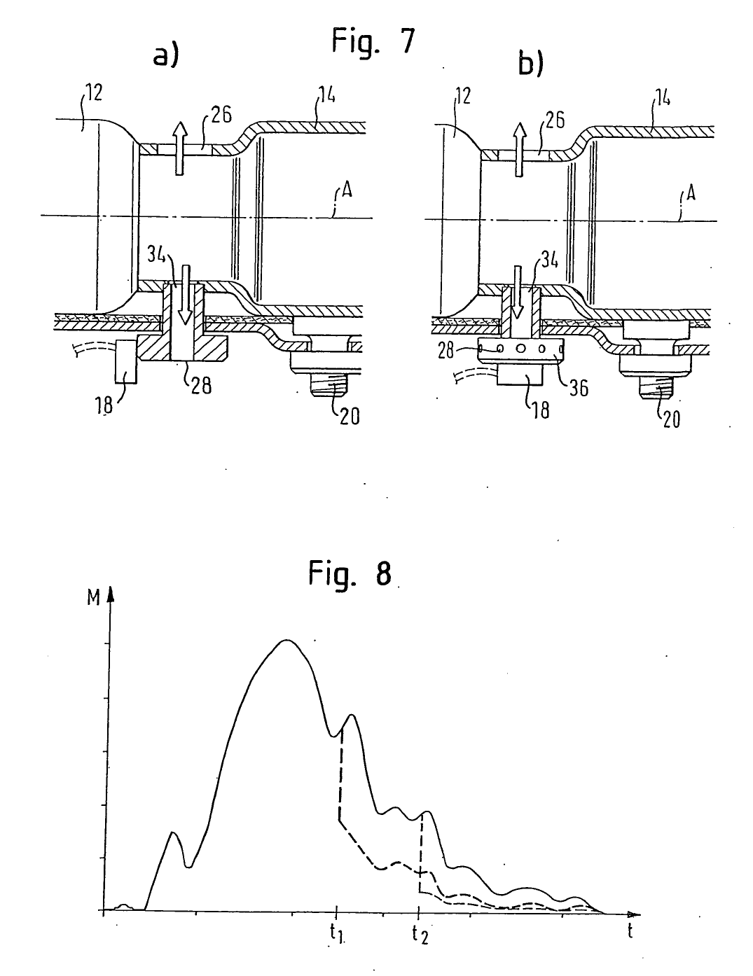

FIGS. 6a and 6b show a fourth embodiment of the gas generator 8, which is very similar to the embodiments according to FIGS. 4 and 5. The pyrotechnical device 18 is provided directly across from the first outflow opening 26. Two variants of this embodiment can be seen in FIGS. 7a and 7b. The distribution cap 36 for discharging the gas in a shear-neutral manner is not absolutely necessary here since even without a distribution cap 36 (FIG. 7a), no resultant force is generated that would expose the attachment bolts 20 to tensile loading. The forces generated when the gas flows out through the first and second outflow openings 26, 28 largely offset each other so that, in this case, very little stress is exerted on the attachment means of the gas generator 8.

The effect of the second outflow openings 28 is illustrated on the basis of a diagram in which the gas mass flow M into the airbag 24 is plotted over time t. Such curves depend, of course, on the shape of the distribution chamber 14 and on the cross sections of the first and second outflow openings 26, 28. Merely by way of an example, the applicable mass flow curve of an advantageous combination is plotted. The solid line indicates the gas mass flow into the airbag 24 if the second outflow openings 28 remain closed. If the second outflow openings 28 are opened at a point in time t₁, then the mass flow M immediately drops to about 50% of the mass flow without the opening of the second outflow openings 28 (thick broken line). If the second outflow openings 28 are opened at the point in time t₂, then the mass flow M drops to about 20% of the original mass flow M (thin broken line). Efforts are aimed at having cross sections and distribution chamber shapes with which, depending on the point in time when the second outflow openings 28 open, a gas mass flow into the airbag 24 is established that lies between 20% and 80% of the value achieved when the second outflow opening is closed.

1. A gas generator (8) for a vehicle occupant restraint system, comprising a gas generator housing (25), said gas generator housing (25) defining a distribution chamber (14) and a generator chamber (12) from which gas flows into said distribution chamber (14) after said gas generator (8) has been activated, said distribution chamber (14) having at least one first outflow opening (26) that conveys said gas into an airbag (24), said distribution chamber (14) further having a pyrotechnical device (18) that, when it is triggered, releases at least one second outflow opening (28) in order to discharge gas to an environment.

2. The gas generator (8) according to claim 1, wherein said pyrotechnical device (18) is an explosive bolt that is arranged in an outer wall of said distribution chamber (14).

3. The gas generator (8) according to claim 1, wherein several second outflow openings (28) are provided and arranged in such a way that they discharge outflowing gas to said environment in a shear-neutral manner.

4. The gas generator (8) according to claim 1, wherein said second outflow opening (28) is integrated into said pyrotechnical device (18).

5. The gas generator (8) according to claim 1, wherein a membrane (30) is present that divides said distribution chamber (14) into two areas, a first area containing said first outflow opening (26) and a second area containing said second outflow opening (28) and, after said pyrotechnical device (18) has been activated, it destroys said membrane (30).

6. The gas generator (8) according to claim 5, wherein said pyrotechnical device (18) is arranged in said second area of said distribution chamber (14).

7. The gas generator (8) according to claim 1, wherein said gas generator (8) is a tubular gas generator with a tube axis (A), said generator chamber (12) and said distribution chamber (14) being arranged axially behind one another.

8. The gas generator (8) according to claim 1, wherein said distribution chamber (14) is formed by a separate part attached to said generator chamber (12).

9. The gas generator (8) according to claim 1, wherein said gas generator (8) is a cold gas generator, said generator chamber (12) having a chamber filled with compressed gas.

10. The gas generator (8) according to claim 1, wherein said gas generator (8) is a hot gas generator, said generator chamber (12) having a combustion chamber.

11. An airbag module having a gas generator (8) according to claim 1, wherein said gas generator (8) is accommodated and attached in a module housing (10), said distribution chamber (14) being configured in such a way that a section of said distribution chamber (14) having said second outflow opening (28) extends through an opening in said module housing (10) in order to discharge gas from said airbag module to said environment.

12. The airbag module according to claim 11, wherein at least one attachment bolt (20) is provided between said distribution chamber (14) and said module housing (10) in order to attach said gas generator (8) to said module housing (10), said pyrotechnical device (18) for releasing said second outflow opening (28) being integrated into said attachment bolt (20).

13. The airbag module according to claim 11, wherein a shape of said distribution chamber (14) and cross sections of said first and second outflow openings (26, 28) are coordinated with each other in such a way that, when said pyrotechnical device (18) is triggered, a gas mass flow into said airbag (24) is established that amounts to between 20% and 80%, preferably about 50%, of a value achieved when said second outflow opening (28) is closed.
